(19) United States
(12) Patent Application Publication
(10) Pub. No.: US 2005/0011331 A1
(43) Pub. Date: Jan. 20, 2005

(54) Constructing expanded range stringed instruments

(76) Inventor: Paul Murrell, Spring Hill, TN (US)

Correspondence Address: Paul Murrell, 1650 Witt Hill Drive, Spring Hill, TN, 37174, US

(21) Appl. No.: 10/618,389

(22) Filed: Jul. 14, 2003

(51) Int. Cl. G10D 3/00

(52) U.S. Cl. 84/290

(57) ABSTRACT

A stringed instrument with a plurality of strings arranged in a non-size sequential order to achieve new string arrangements. This invention teaches a tuned string arrangement for a stringed instrument or guitar with the tuned string arrangement utilizing a tuning sequence of ‘low E,’ ‘extra low A,’ ‘d,’ ‘high g,’ ‘low B,’ and ‘high e.’ The standard prior art sequential string size order is altered by placing the sixth string of a conventional guitar string set in the sixth position, placing an extra large selected replacement string that is to be tuned one octave lower than the string it replaces in the fifth position, placing the fourth string of the conventional guitar string set in the fourth position, placing a replacement string slightly smaller than the first string of the conventional guitar string set in the third position, placing the fifth string of the conventional guitar string set in the second position and placing the first string of the conventional guitar string set in the first position. After the string changes and replacements have been made each string is tuned to the note name of its present position. (It should be noted the tuning of the present invention may be altered at the discretion of the musician using it.) For playing purposes the instrument is played as if the string replacements and changes have not occurred. The fingering remains identical to the conventional (classical) guitar enabling the musician to produce new pitch levels from the string size selections and position placements. In addition, the revised instrument has an open string range of two octaves and a minor seventh interval—a minor seventh interval greater than the open string range of the conventional guitar.

### BACKGROUND OF THE INVENTION

The present invention relates generally to constructing stringed instruments. More particularly, this invention pertains to constructing stringed instruments, such as guitars, in a manner that varies the string size selections and the order of the placements of the strings to produce new and novel sounds while playing the instrument in a conventional method.

As shown in FIG. 1, there is illustrated a conventional stringed instrument 10, illustrated in the preferred embodiment as a guitar 10, for purposes of this description. Stringed instruments 10 such as guitars are constructed generally of a body section 12, a narrow elongated fingerboard 14, a head 16, supporting elements commonly referred to as a bridge 18 and a nut 20, and strings 15. The strings 15 include six strings tuned in order to define a ‘low E’ string 22, a ‘low A’ string 24, a ‘d’ string 26, a ‘g’ string 28, a ‘high b’ string 30, and a ‘high e’ string 32 respectively.

The strings 15 are attached in size-sequential order to the stringed instrument 10. The tuned strings are constructed to produce individual notes and the names correspond to the tuned notes, i.e. ‘low E’ string 22 means a string tuned to the ‘low E’ note and likewise for the ‘low A’ string 24, ‘d’ string 26, ‘g’ string 28, ‘high b’ string 30, and ‘high e’ string 32 which is constructed with the least or narrowest diameter. For a typical setup, the ‘low E’ string 22 with a diameter of 0.046 inches is placed in the sixth position 34, the ‘low A’ string 24 with a diameter of 0.036 inches is placed in the fifth position 36, the ‘d’ string 26 with a diameter of 0.026 inches is placed in the fourth position 38, the ‘g’ string 28 with a diameter of 0.017 inches is placed in the third position 40, the ‘high b’ string 30 with a diameter of 0.013 inches is placed in the second position 42, and the ‘high e’ string 32 with a diameter of 0.010 inches is placed in the first position 44. These are approximate dimensions that may vary depending upon the string design and other well known factors in the prior art. Thus, an example of the typical variations for the ‘low E’ string 22, are string diameters which vary from 0.040 inches to 0.052 inches.

The strings 15 are maintained in proper order and spacing along the stringed instrument 10 by the supporting elements. The first supporting element positions one end of the strings 15 and is commonly referred to as a nut 20 that is affixed between the fingerboard 14 and head 16. The second supporting element supports the other end of the strings 15 and is commonly referred to as a bridge 18. As an example of a string mounting arrangement for the ‘low E’ string 22 the second end of the ‘low E’ string 22 is placed in the sixth position 34 and the first end of the string 22 is attached to its tuning key 17.

In this manner the following music intervals are produced: perfect fourth intervals between ‘low E’ string 22 and ‘low A’ string 24, between ‘low A’ string 24 and ‘d’ string 26, and between ‘d’ string 26 and ‘g’ string 28: a major third interval between ‘g’ string 28 and ‘high b’ string 30; and a perfect fourth interval between ‘high b’ string 30 and ‘high e’ 32. As a result of the sequence with which the strings 15 are attached to the instrument 10, the instrument 10 produces a unique and distinctive sound. This sound can be varied to some degree by tuning individual strings 15. However, the player soon learns that the instrument 10 is limited in its ability to produce unusual melodies and harmonies during conventional playing. A player may attempt to produce unique sounds by varying the sequence of striking the strings 15 in order to produce new music intervals. However, this procedure ultimately may produce a haphazard and undesirable effect.

As illustrated in the background art, efforts are continuously being made in an attempt to develop devices that improve the performance of stringed instruments, such as guitars and the like. No prior effort, however, provides the benefits attendant with the present invention. As such, it may be appreciated that there is a continuing need to produce novel and unusual sounds from stringed instruments in a manner that is similar to that of playing a conventional stringed instrument. In these respects, the present version of the invention substantially departs from the conventional concepts and designs of the prior art, and in so doing provides an apparatus that substantially fulfills this need. Additionally, the prior patents and commercial techniques do not suggest the present inventive combination of component elements arranged and configured as disclosed herein. The present invention achieves its intended purposes, objects and advantages through a new, useful and unobvious combination of method steps and component elements with the use of a minimum number of functioning parts at a reasonable cost to manufacture, and by employing only readily available materials.

What is needed then to overcome the said limitations of conventional stringed instruments is the provision of stringed instruments that are fitted with varying string size selections and string position placements. The present invention meets the requirements of such instruments while also offering an instrument with an open stringed range much larger than the open string range of a conventional (classical) guitar.

### SUMMARY OF THE INVENTION

The present version of the invention, which will be described in greater detail hereinafter, relates to the field of constructing stringed instruments. More specifically, this version of the invention is concerned with constructing stringed instruments such as guitars in a manner that varies the order of the placement of the strings in order to produce new and novel sounds while playing the instrument in a conventional method. The present invention overcomes all of the shortcomings of the prior art and provides some additional novel aspects that will be described in detail hereinafter.

Described briefly, according to a typical embodiment, the invention presents a method of construction for producing unusual harmonies and melodies from conventional stringed instruments such as guitars by varying the sequence of the order of the strings that are attached to the instrument. Conventional guitars employ six strings the first string is tuned to ‘high e’, the second string is tuned to ‘high b’, the third string is tuned to ‘g’, the fourth string is tuned to ‘d’, the fifth string is tuned to ‘low A’, and the sixth string is tuned to ‘low E.’ Each string is attached at one end to a tuning mechanism at the head of said instrument and attached at the other end to the body of the instrument approximate to a bridge. The bridge and a nut maintain the strings in the proper sequence and spacing relative to each other and at the optimum distance above the body and fingerboard of the instrument. The strings also proceed sequentially with a string of a largest diameter tuned ‘low E’, to a string of least diameter tuned ‘high e’.

The method of constructing the present invention consists of placing the sixth string of a conventional guitar string set in the sixth position, placing an extra large selected replacement string that is to be tuned one octave lower than the string it replaces in the fifth position, placing the fourth string of the conventional guitar string set in the fourth position, placing a replacement string slightly smaller than the first string of the conventional guitar string set in the third position, placing the fifth string of the conventional guitar string set in the second position and placing the first string of the conventional guitar string set in the first position. The revised tuning sequence of the strings has the actual tuning nomenclature of ‘low E,’ ‘extra low A,’ ‘d,’ ‘high g,’ ‘low B,’ and ‘high e.’

Another version of the invention is easily realized by replacing the ‘low B’ string with an ‘extra high b’ string, resulting in a larger ranged and brighter sounding instrument.

For playing purposes the instrument is played as if the varying string size selections and string order placements had not been implemented. The stringed instrument of the instant invention is thus played in the normal technique, i.e. conventional fingering while allowing the player to elicit altered pitch levels from the strings. This revised positioning of the strings allows the player to produce heretofore unattainable melodies, harmonies and reversed rhythmic accents without learning new fingering positions or playing techniques.

The present invention, therefore, is distinguished from the prior art in its particular combination of its structures for the functions specified. Accordingly it is an object of this version of the invention to provide a low-cost, easy-to-manufacture and easy-to-market method of constructing revised position stringed instruments. A further object of this version of the invention is to provide an easy-to-use and versatile method of constructing stringed instruments. A significant object of the invention is to provide a method of constructing stringed instruments that can be adapted to a variety of instruments that employ a sequenced arrangement of tuned strings.

A final but very significant object of the invention is to provide a method of construction of stringed instruments that have varying string size selections and string order placements to yield new and unusual harmonies, melodies and rhythmic accents while playing the instrument in a conventional manner.

The foregoing and other objects, features and advantages of the invention will become more fully understood from the following description of the preferred embodiment of the invention as illustrated in the accompanying drawings in which like reference characters refer to the same parts throughout different views. The drawings are not necessarily to scale, emphasis instead being placed upon illustrating the principles of the invention.

### BRIEF DESCRIPTION OF THE DRAWINGS

FIG. 1 is a perspective view of a conventional stringed guitar.

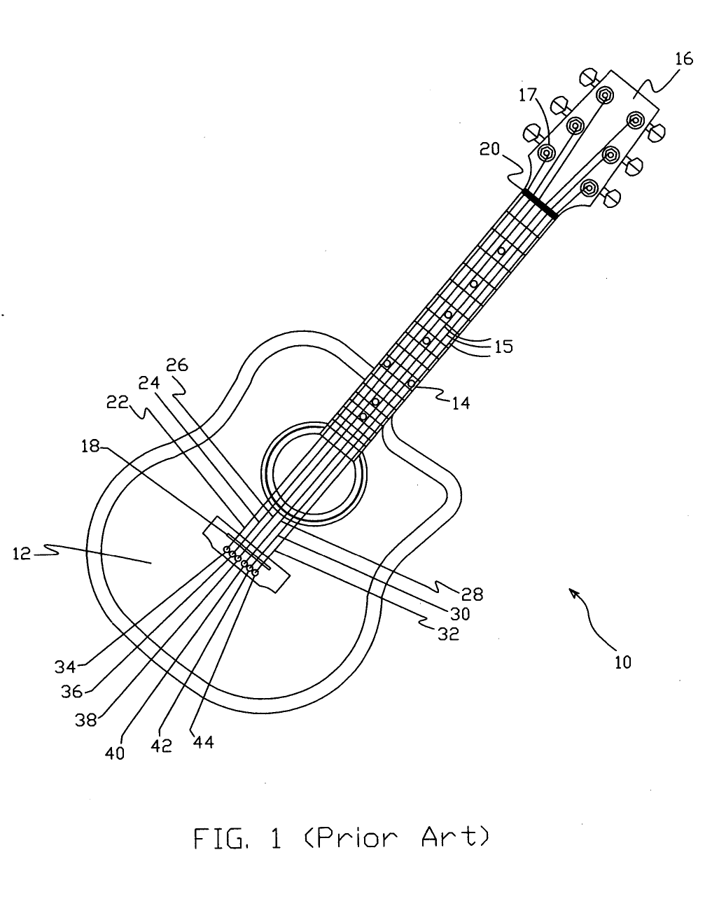

FIG. 2 is a perspective view of a stringed guitar constructed in accordance with the present version of the invention.

FIG. 3 is a schematic sheet music diagram showing the tuning sequence of the strings on the conventional guitar and the tuning sequence of the strings on the present invention.

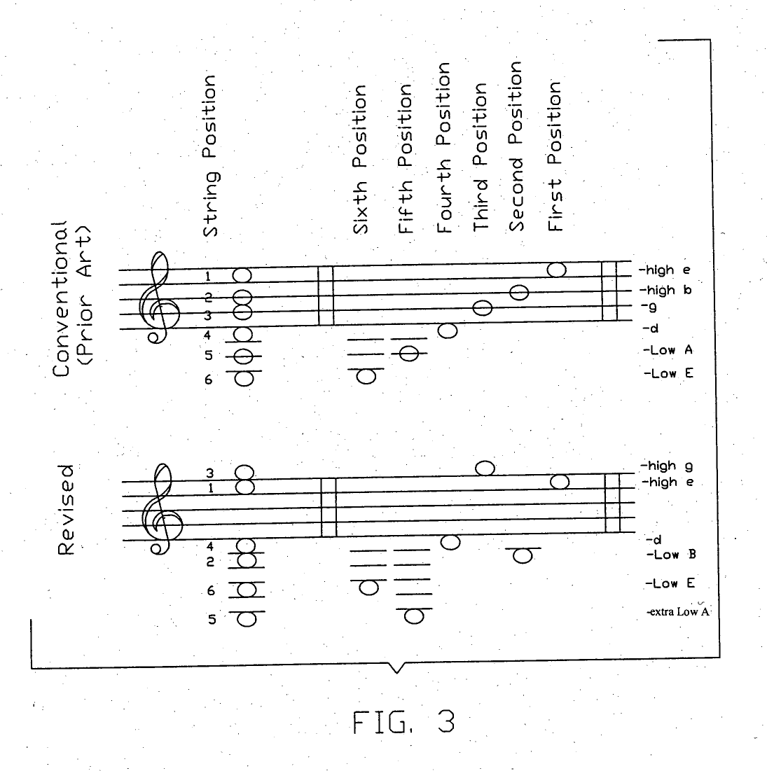

### DESCRIPTION OF THE PREFERRED EMBODIMENTS

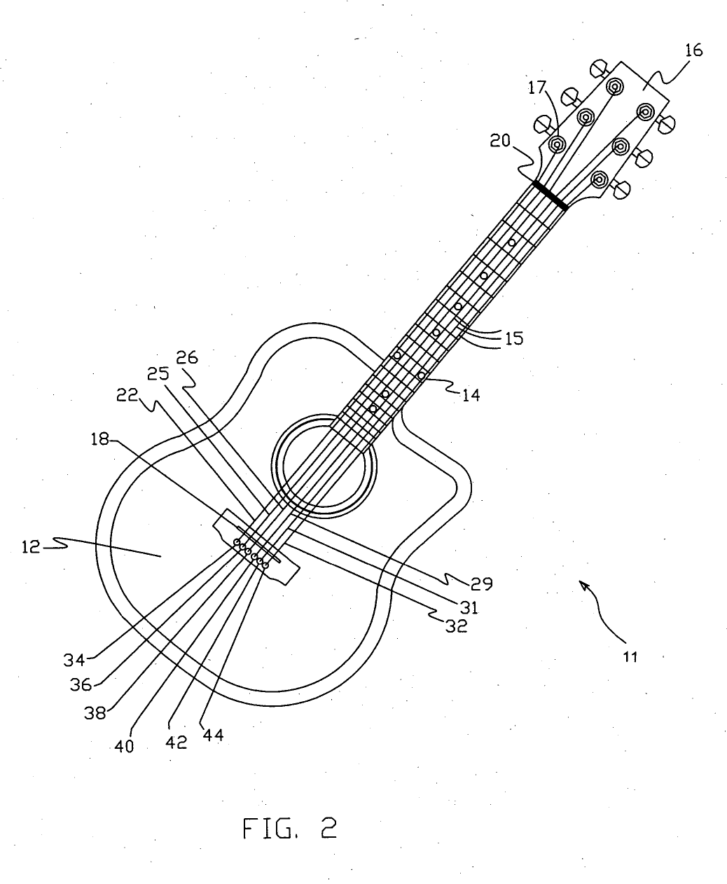

Referring to FIG. 2 therein illustrated is the alternate stringed guitar 11 of the instant invention. This invention teaches a tuned string arrangement for a stringed instrument or guitar with the tuned string arrangement utilizing a tuning sequence of ‘low E,’ ‘extra low A,’ ‘d,’ ‘high g,’ ‘low B,’ and ‘high e.’

In contrast to the said typical conventional guitar string size set up a typical guitar string size set up for the present invention consist of the ‘low E’ string 22 with a diameter of 0.046 inches placed in the sixth position 34, the ‘extra low A’ string 25 with a diameter of 0.065 inches placed in the fifth position 36, the ‘d’ string 26 with a diameter of 0.026 inches placed in the fourth position 38, the ‘high g’ string 29 with a diameter of 0.009 inches placed in the third position 40, the ‘low B’ string 31 with a diameter of 0.036 inches placed in the second position 42 and the ‘high e’ string 32 with a diameter of 0.010 inches placed in the first position 44.

The intervals of the open strings of the present invention are as follows:
a perfect fifth interval between the string of the sixth position 34 tuned to ‘low E’ and the string of the fifth position 36 tuned to ‘extra low A,’ an octave and a perfect fourth interval between the string of the fifth position 36 tuned to ‘extra low A’ and the string of the fourth position 38 tuned to ‘d,’ an octave and a perfect fourth interval between the string of the fourth position 38 tuned to ‘d’ and the string of the third position 40 tuned to ‘high g,’ an octave and a minor sixth interval between the string of the third position 40 tuned to ‘high g’ and the string of the second position 42 tuned to ‘low B,’ an octave and a perfect fourth interval between the string of the second position 42 tuned to ‘low B’ and the string of the first position 44 tuned to ‘high e.’

In this manner the invention presents a string size order rearrangement for non-sequential string size selections and placements which presents and allows a different guitar tuning than may be performed by typical alternate guitar tunings that utilize strings placed in the same locations as the strings of a conventional guitar. Thus the present invention provides for rearrangement or replacement of the guitar strings except for the strings of the sixth, fourth, and first positions.

The conventional guitar only has a two octave range in the open string position between the largest and smallest strings. The revised guitar utilizes a two octave and a minor seventh range between the largest and smallest strings in the open string position —allowing the guitarist to easily execute chords and harmonies that would be physically impossible on a conventional guitar.

It will be appreciated by those skilled in the art that the present invention is not an alternate guitar tuning but is an improvement in string size selections and string position placements. Each string is tuned to the note name common to the string position in which it has been placed. It should be noted that the tuning of the present invention may be altered at the discretion of the musician playing it.

### SOME ADVANTAGES OF THE PRESENT INVENTION

1) The player does not need to learn new techniques—fingering and chord shapes—to produce many novel sounds. The present invention is played exactly like the conventional (classical) guitar.
2) Although the pitch levels of many of the notes of the instrument have been changed the note names of all the frets and open strings remain unchanged.
3) The present invention and a conventional guitar can be played simultaneously by two guitarists using the same fingerings, chord shapes and rhythms to produce previously unheard, ear catching sound effects.
4) The guitarist can easily learn “new guitar” sounds by reading music in the usual manner and listening to the altered pitch levels of the notes of the present invention.
5) Its open string range is a minor seventh interval (ten frets) greater than the open string range of the conventional guitar allowing the listener to experience the extra low open ‘A’ string note and the high open third string ‘g’ note. These notes are not available on the conventional guitar.
6) The large range of the improved guitar enables a single skilled player to simulate two musicians performing a duet—one playing a bass and the other a guitar.
7) Whether played together or in succession the notes of the huge music intervals between adjacent strings result in a stunning sound impact.

1) A revised string arrangement for a musical instrument utilizing a first string with a first diameter, a second string with a second diameter larger than the first diameter, a third string with a third diameter larger than the second diameter, a fourth string with a fourth diameter larger than the third diameter, a fifth string with a fifth diameter larger than the fourth diameter, and a sixth string with a sixth diameter larger than the fifth diameter, in which strings are selectively placed into a string placement arrangement including a first position, a second position adjacent to the first position, a third position adjacent to the second position, a fourth position adjacent to the third position, a fifth position adjacent to the fourth position, and a sixth position adjacent to the fifth position, comprising:
the sixth string placed in the sixth position;
an extra large replacement string placed in the fifth position;
the fourth string placed in the fourth position;
a replacement string slightly smaller than the first string placed in the third position;
the fifth string placed in the second position;
the first string placed in the first position.

2) The revised string arrangement of claim 1, in which
the first position string is tuned to the ‘high e’ note;
the second position string is tuned to the ‘low B’ note;
the third position string is tuned to the ‘high g’ note;
the fourth position string is tuned to the ‘d’ note;
the fifth position string is tuned to the ‘extra low A’ note; and
the sixth position string is tuned to the ‘low E’ note.

3) A stringed instrument employing
a body;
a fingerboard attached to the body;
a head attached to the fingerboard;
a bridge attached to the body section;
a nut attached in association with the first end of the fingerboard;
a plurality of different size strings arranged in an order that is not sequentially arranged according to the size of the strings.
the strings include a ‘low E’ string, an ‘extra low A’ string, a ‘d’ string, a ‘high g’ string, a ‘low B’ string and a ‘high e’ string.

4) The stringed instrument of claim 3, wherein the non-size string sequential order includes the ‘low E’ string located next to the ‘extra low A’ string, located next to the ‘d’ string, located next to the ‘high g’ string, located next to the ‘low B’ string, located next to the ‘high e’ string.

5) A tuned string arrangement for a musical instrument with a first string position, a second string position adjacent to the first string position, a third string position adjacent to the second string position, a fourth string position adjacent to the third string position, a fifth string position adjacent to the fourth string position and a sixth string position adjacent to the fifth string position, the tuned string arrangement comprising; a perfect fifth interval between the string of the sixth position tuned to ‘low E’ and the string of the fifth position tuned to ‘extra low A,’ an octave and a perfect fourth interval between the string of the fifth position tuned to ‘extra low A’ and the string of the fourth position tuned to ‘d,’ an octave and a perfect fourth interval between the string of the fourth position tuned to ‘d’ and the string of the third position tuned to ‘high g,’ an octave and a minor sixth interval between the string of the third position tuned to ‘high g’ and the string of the second position tuned to ‘low B,’ an octave and a perfect fourth interval between the string of the second position tuned to ‘low B’ and the string of the first position tuned to ‘high e.’

6) A tuned stringed arrangement for guitar comprising a tuning sequence of ‘low E,’ ‘extra low A,’ ‘d,’ ‘high g,’ ‘low B,’ and ‘high e.’
